(19) United States
(12) Patent Application Publication
(10) Pub. No.: US 2008/0316411 A1
(43) Pub. Date: Dec. 25, 2008

(54) ARRAY SUBSTRATE AND LIQUID CRYSTAL DISPLAY HAVING THE SAME

(75) Inventors: Min-Hyung CHOO, Seongnam-si (KR); Min-Wook PARK, Asan-si (KR); Young-Goo SONG, Suwon-si (KR); In-Woo KIM, Yongin-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/777,773

(22) Filed: Jul. 13, 2007

(30) Foreign Application Priority Data
Jul. 20, 2006 (KR) 2006-68076

(51) Int. Cl. G02F 1/1343

(52) U.S. Cl. 349/140

(57) ABSTRACT

An array substrate includes light blocking parts formed under a semiconductor line. The light blocking parts have an electric potential lower than a critical electric potential, at which a short occurs, thereby minimizing the electric potential difference between the light blocking parts and the adjacent lines when an electrostatic field is applied to the light blocking parts.

### CROSS REFERENCE TO RELATED APPLICATION

This application claims priority from and the benefit of Korean Patent Application No. 2006-68076, filed on Jul. 20, 2006, which is hereby incorporated by reference for all purposes as if fully set forth herein.

### BACKGROUND OF THE INVENTION

1. Field of Invention

The present invention relates to an array substrate and a liquid crystal display including the array substrate. More particularly, the present invention relates to an array substrate capable of improving the yield thereof and a liquid crystal display including the array substrate.

2. Discussion of the Background

In general, a liquid crystal display includes an array substrate, a color filter substrate facing the array substrate, and a liquid crystal layer disposed between the array substrate and the color filter substrate.

The array substrate includes a plurality of pixel portions to display an image thereon. Each pixel portion has a gate line, a data line, a thin film transistor, and a pixel electrode. The gate line and the data line transmit a gate signal and a data signal, respectively, and are connected to a gate electrode and a source electrode of the thin film transistor, respectively. The pixel electrode is connected to a drain electrode of the thin film transistor and faces a common electrode formed on the color filter substrate.

Generally, the data line and a semiconductor layer of the thin film transistor are formed using separate masks. However, a method that forms the data line and the semiconductor layer using one mask has been developed in order to reduce the number of masks required and the manufacturing cost of the liquid crystal display. According to this method, the semiconductor layer is formed under the data line. When the semiconductor layer is formed under the data line, light generated from a backlight assembly reaches the semiconductor layer before the liquid crystal layer because the backlight assembly is disposed under the array substrate. The light provided to the semiconductor layer causes variations in the electrical properties of the semiconductor layer, which varies the level of voltage applied to the pixel electrode, thereby causing a moiré on the displayed image.

In order to prevent the moiré, the array substrate may further include a light blocking pattern formed under the semiconductor layer. The light blocking pattern is formed on the same layer on which the gate line and a common voltage line for the common electrode are formed and is insulated from adjacent lines. However, when an electrostatic field occurs in the array substrate, an electric potential difference may be created between the light blocking pattern and the common voltage line, which can cause a short between the data line and the common voltage line.

In other words, when the electrostatic field occurs in the array substrate, heat caused by the electric potential difference is generated in the portion of the array substrate adjacent to the common voltage line, which causes the gate insulation layer and the data line to melt. As a result, a short may occur between the data line and the common voltage line, and the liquid crystal display cannot properly display the image.

### SUMMARY OF THE INVENTION

The present invention provides an array substrate that may have an improved yield.

The present invention also provides a liquid crystal display including the above array substrate.

Additional features of the invention will be set forth in the description which follows, and in part will be apparent from the description, or may be learned by practice of the invention.

The present invention discloses an array substrate including a base substrate and at least one pixel part disposed on the base substrate to display an image. The pixel part includes a first signal line, a second signal line, a semiconductor line, and a plurality of light blocking parts. The first signal line extends in a first direction to transmit a first signal corresponding to the image. The second signal line extends in a second direction substantially perpendicular to the first direction to transmit a second signal corresponding to the image. The second signal line is insulated from and crosses the first signal line. The semiconductor line is disposed between the base substrate and the second signal line and disposed at a position corresponding to the second signal line. The light blocking parts are disposed under the semiconductor line and are spaced apart from each other to block light. Each light blocking part has a lower electric potential than a critical electric potential that causes a short between the light blocking parts and an adjacent line to the light blocking parts.

The present invention also discloses an array substrate including a base substrate and at least one pixel part disposed on the base substrate to display an image. The pixel part includes a first gate line disposed on a layer and extending in a first direction to transmit a gate signal corresponding to the image and a second gate line disposed on the layer and substantially parallel to the first gate line to transmit the gate signal. A common voltage line is disposed between the first gate line and the second gate line to transmit a common voltage and is substantially parallel to the first gate line and the second gate line. A data line extends in a second direction substantially perpendicular to the first direction to transmit a data signal corresponding to the image. The data line is insulated from and crosses the first gate line, the second gate line, and the common voltage line. A semiconductor line is disposed between the base substrate and the data line and is disposed at a position corresponding to the data line and a plurality of light blocking parts are disposed under the semiconductor line and are spaced apart from each other to block light. At least two light blocking parts are disposed between the first gate line and the common voltage line, one light blocking part is disposed between the common voltage line and the second gate line, and one light blocking part is disposed between the second gate line and a first gate line of an adjacent pixel part. Each light blocking part has a lower electric potential than a critical electric potential that causes a short between the light blocking parts and the first gate line, the second gate line, and the common voltage line.

The present invention also discloses a liquid crystal display including an array substrate including a base substrate and at least one pixel part disposed on the base substrate to display an image. An opposite substrate is coupled to the array substrate and a liquid crystal layer is interposed between the array substrate and the opposite substrate to control a light transmittance thereof. The pixel part includes a first signal line extending in a first direction to transmit a first signal corresponding to the image and a second signal line extending in a second direction substantially perpendicular to the first direction to transmit a second signal corresponding to the image, the second signal line being insulated from and crossing the first signal line. A semiconductor line is disposed between the base substrate and the second signal line and is disposed at a position corresponding to the second signal line and a plurality of light blocking parts are disposed under the semiconductor line and spaced apart from each other to block light. Each light blocking part has a lower electric potential than a critical electric potential that causes a short between the light blocking parts and a line adjacent to the light blocking parts.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a plan view showing an exemplary embodiment of an array substrate according to the present invention.

FIG. 2 is a plan view showing the semiconductor line and the light blocking part shown in FIG. 1.

FIG. 3 is a cross-sectional view taken along line I-I′ of FIG. 1.

FIG. 4 is an enlarged plan view of a portion “A” of FIG. 2.

FIG. 5 is a cross-sectional view taken along line II-II′ of FIG. 1.

FIG. 6 is a cross-sectional view showing an exemplary embodiment of a liquid crystal display of the present invention.

FIG. 7 is an equivalent circuit diagram of the liquid crystal display shown in FIG. 6.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

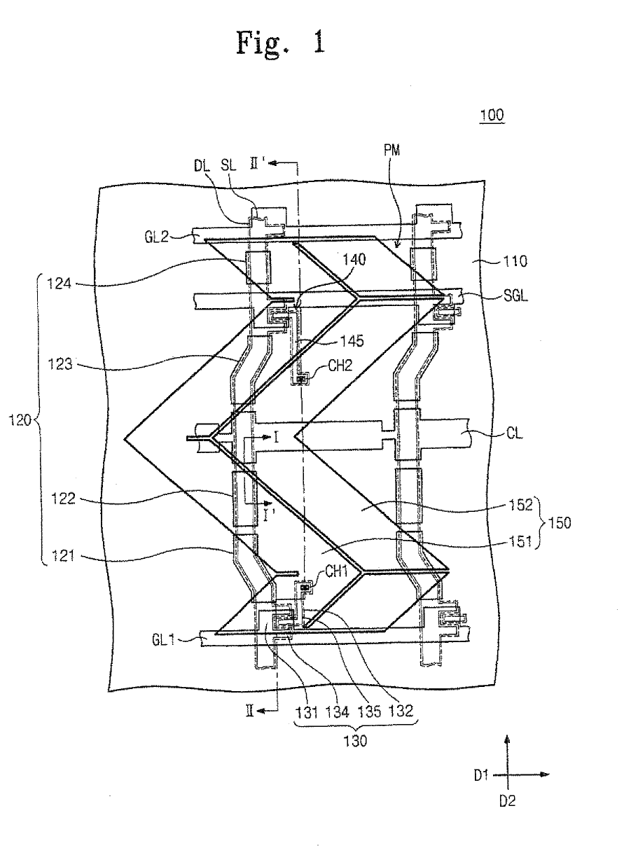

FIG. 1 is a plan view showing an exemplary embodiment of an array substrate according to the present invention.

Referring to FIG. 1, an array substrate 100 includes a first base substrate 110 and at least one pixel portion PM.

The base substrate 110 includes a transparent material through which external light passes.

The pixel portion PM is formed on the base substrate 110 and serves as a basic unit displaying an image. The array substrate 100 may include a plurality of pixel portions PM to display the image. In the present invention, the plurality of pixel portions may have the same configuration, and as such, only one pixel portion will be described in detail in order to avoid redundancy.

The pixel portion PM includes a gate line GL1, a data line DL, a semiconductor line SL, a plurality of light blocking parts 120, a first thin film transistor 130, a second thin film transistor 140, and a pixel electrode 150.

The gate line GL1 extends in a first direction D1 and transmits a gate signal. The data line DL extends in a second direction D2 that is substantially perpendicular to the first direction D1 and transmits a data signal. The data line DL is insulated from the gate line GL1 and crosses the gate line GL1 to define the pixel portion PM.

The pixel portion PM further includes a sub gate line SGL and a common voltage line CL, which are substantially parallel to the gate line GL1. The sub gate line SGL and the common voltage line CL are formed on the same layer as the gate line GL1, and the sub gate line SGL and the common voltage line CL are insulated from the data line DL and cross the data line DL. The sub gate line SGL is positioned adjacent to a gate line GL2 in a previous pixel portion and transmits the gate signal. The common voltage line CL is formed between the gate line GL1 and the sub gate line SGL and transmits a common voltage.

The semiconductor line SL is formed at a position corresponding to the data line DL, and the light blocking parts 120 are formed under the semiconductor line SL.

The semiconductor line SL and the light blocking parts 120 will be described in detail below.

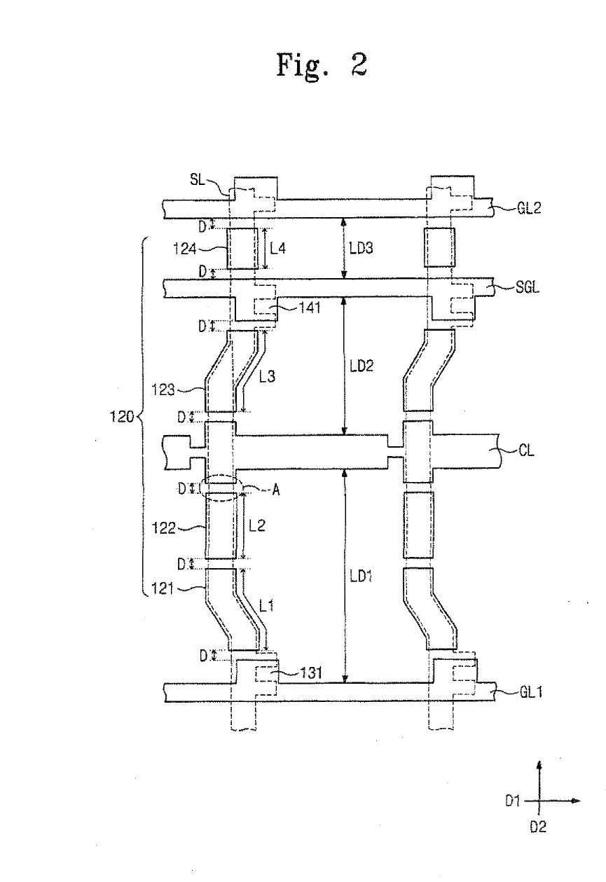

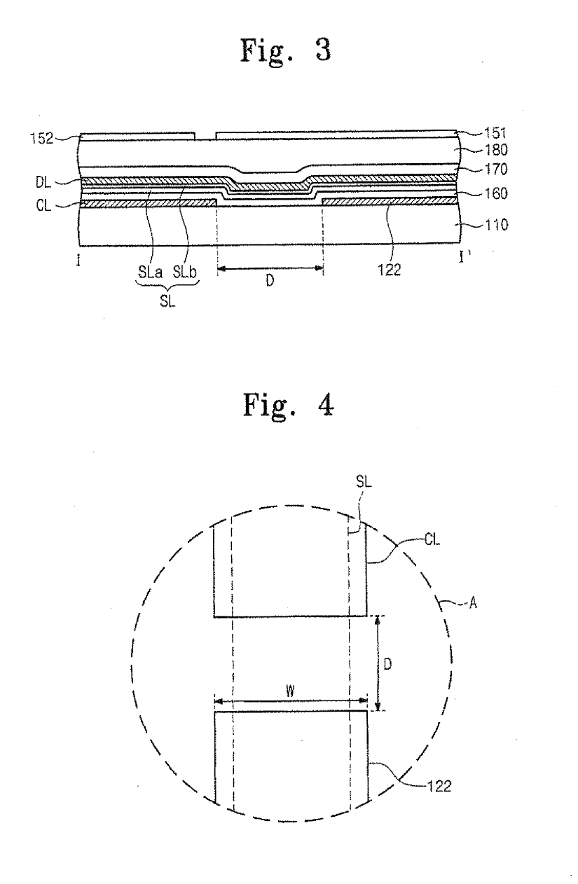

FIG. 2 is a plan view showing the semiconductor line and the light blocking parts shown in FIG. 1, FIG. 3 is a cross-sectional view taken along line I-I′ of FIG. 1, and FIG. 4 is an enlarged plan view of a portion “A” of FIG. 2.

Referring to FIG. 2, FIG. 3, and FIG. 4, the light blocking parts 120 include a first light blocking part 121, a second light blocking part 122, a third light blocking part 123, and a fourth light blocking part 124.

In the present embodiment, the pixel portion PM includes four light blocking parts 121, 122, 123, and 124. However, the number of the light blocking parts 120 may be increased or decreased according to a size of the pixel portion PM.

The first, second, third, and fourth light blocking parts 121, 122, 123, and 124 are arranged along the second direction D2 such that the first, second, third, and fourth light blocking parts 121, 122, 123, and 124 are spaced apart from each other.

Particularly, the first and second light blocking parts 121 and 122 are formed between the gate line GL1 and the common voltage line CL, the third light blocking part 123 is formed between the common voltage line CL and the sub gate line SGL, and the fourth light blocking part 124 is formed between the sub gate line SGL and the gate line GL2 in the previous pixel portion.

In the present embodiment, the first, second, third, and fourth light blocking parts 121, 122, 123, and 124 are formed under the semiconductor line SL and on the same layer as the gate line GL1. The second light blocking part 122 among the first, second, third, and fourth light blocking parts 121, 122, 123, and 124 will be described in detail.

The second light blocking part 122 includes a metal material that may block light and is formed together with the gate line GL1 on the first base substrate 110.

A gate insulation layer 160 is formed on the first base substrate 110 on which the second light blocking part 122 and the gate line GL1 are formed, and the semiconductor line SL is formed on the gate insulation layer 160. The semiconductor line SL includes an active line SLa and an ohmic line SLb which include amorphous silicon and n+ amorphous silicon, respectively. The active line SLa is formed on the gate insulation layer 160, and the ohmic line SLb is formed on the active line SLa.

The semiconductor line SL is formed in an area corresponding to the data line DL and is formed when the data line DL is formed. Thus, the semiconductor line SL and the data line DL may be formed using only one mask, thereby reducing the number of masks required and the manufacturing cost of the array substrate 100.

Since the semiconductor line SL includes amorphous silicon, the electrical properties of the semiconductor line SL may vary. However, as shown in FIG. 3, the second light blocking part 122 formed under the semiconductor line SL may block light advancing toward the semiconductor line SL, thereby preventing variation of the electrical properties of the semiconductor line SL.

As describe above, the first, second, third, and fourth light blocking parts 121, 122, 123, and 124 formed under the semiconductor line SL may block light advancing toward the semiconductor line SL, thereby preventing variation of the electrical properties of the semiconductor line SL. Thus, the array substrate 100 may prevent the occurrence of the moire due to variation of the electrical properties of the semiconductor line SL.

The first, second, third, and fourth light blocking parts 121, 122, 123, and 124 are spaced apart and insulated from adjacent lines such as the gate line GL1, the sub gate line SGL, and the common voltage line CL. In the exemplary embodiment, the first, second, third, and fourth light blocking parts 121, 122, 123, and 124 are spaced apart from the respective adjacent lines at equal distances D.

The first, second, third, and fourth light blocking parts 121, 122, 123, and 124 have an electric potential that is lower than the critical electric potential, which is the electric potential that would cause a short between the light blocking parts 120 and the adjacent lines when an electrostatic field occurs at the array substrate 100.

Particularly, when the electrostatic field is applied to the first, second, third, and fourth light blocking parts 121, 122, 123, and 124, the electric charge of the first, second, third, and fourth light blocking parts 121, 122, 123, and 124 increases, causing a short between the data line DL and the common voltage line CL.

For example, when the electrostatic field is applied to the second light blocking part 122, the electric charge and the electric potential of the second light blocking part 122 increase. Since the electric potential of the common voltage line CL adjacent to the second light blocking part 122 is maintained at zero volts, the electric potential difference between the second light blocking part 122 and the common voltage line CL increases, which causes heat between the second light blocking part 122 and the common voltage line CL. As a result, the gate insulation layer 160 between the second light blocking part 122 and the common voltage line CL melts together with the data line DL, causing a short between the data line DL and the common voltage line CL.

In order to prevent the short between the data line DL and the common voltage line CL, the first, second, third, and fourth light blocking parts 121, 122, 123, and 124 have an area smaller than the area corresponding to the critical electric potential. That is, the electric charge of each first, second, third, and fourth light blocking part 121, 122, 123, and 124 is proportional to the area of each first, second, third, and fourth light blocking part 121, 122, 123, and 124, respectively, and the electric potential of each first, second, third, and fourth light blocking part 121, 122, 123, and 124 is proportional to the electric charge of each first, second, third, and fourth light blocking part 121, 122, 123, and 124, respectively. Thus, when the area of the light blocking parts 120 increases, the electric potential of the light blocking parts 120 also increases.

Therefore, when the area of each first, second, third, and fourth light blocking part 121, 122, 123, and 124 is smaller than the area corresponding to the critical electric potential, each of the first, second, third, and fourth light blocking parts 121, 122, 123, and 124 is maintained at an electric potential lower than the critical electric potential, even if an electrostatic field is applied to the first, second, third, and fourth light blocking parts 121, 122, 123, and 124. As a result, a short between the data line DL and the common voltage line CL, which is caused by the increase of the electric potential difference between the light blocking parts 120 and the adjacent lines, may be prevented.

The area of each first, second, third, and fourth light blocking part 121, 122, 123, and 124 depends on the length and the width of each first, second, third, and fourth light blocking part 121, 122, 123, and 124.

In the exemplary embodiment, the first, second, third, and fourth light blocking parts 121, 122, 123, and 124 have equal widths W, and the widths W of the first, second, third, and fourth light blocking parts 121, 122, 123, and 124 depends on the width of the semiconductor line SL.

Since the width W of each first, second, third, and fourth light blocking part 121, 122, 123, and 124 depends on the width of the semiconductor line SL, the degree to which the area of each first, second, third, and fourth light blocking part 121, 122, 123, and 124 may be altered by varying the width W of each first, second, third, and fourth light blocking part 121, 122, 123, and 124 is limited.

Thus, the lengths L1, L2, L3, and L4 of the first, second, third, and fourth light blocking parts 121, 122, 123, and 124 may be shortened or lengthened in order to alter the area of each first, second, third, and fourth light blocking part 121, 122, 123, and 124.

The common voltage line CL is spaced apart from the gate line GL1 by a first distance LD1 and is spaced apart from the sub gate line SGL by a second distance LD2, which is smaller than the first distance LD1. The sub gate line SGL is spaced apart from the gate line GL2 in the previous pixel portion by a third distance LD3, which is smaller than the second distance LD2. Thus, the first, second, third, and fourth light blocking parts 121, 122, 123, and 124 have different lengths L1, L2, L3, and L4.

Further, the distance D between the first, second, third, and fourth light blocking parts 121, 122, 123, and 124 and the respective adjacent lines serves as a factor determining the area corresponding to the critical electric potential. That is, when the distance D between the first, second, third, and fourth light blocking parts 121, 122, 123, and 124 and the respective adjacent lines decreases, a short between the data line DL and the common voltage line CL is more likely due to the electric potential difference between the first, second, third, and fourth light blocking parts 121, 122, 123, and 124 and the common voltage line CL.

For example, when the width of each first, second, third, and fourth light blocking parts 121, 122, 123, and 124 is about 9 micrometers to about 11 micrometers and the distance D from the adjacent lines is about 10 micrometers to about 14 micrometers, the lengths L1, L2, L3, and L4 of the first, second, third, and fourth light blocking parts 121, 122, 123, and 124 are about 180 micrometers to about 190 micrometers. Thus, each of the first, second, third, and fourth light blocking parts 121, 122, 123, and 124 has an area of about 1,620 square micrometers to about 2,090 square micrometers. When the lengths L1, L2, L3, and L4 are smaller than 180 micrometers, each of the first, second, third, and fourth light blocking parts 121, 122, 123, and 124 has an electric potential lower than the critical electric potential.

When each of the first, second, third, and fourth light blocking parts 121, 122, 123, and 124 has a width W of about 10 micrometers and the distance D between the first, second, third, and fourth light blocking parts 121, 122, 123, and 124 and the respective adjacent lines is about 12 micrometers, the lengths L1, L2, L3, and L4 of the first, second, third, and fourth light blocking parts 121, 122, 123, and 124 are equal to or less than about 185 micrometers.

As described above, the lengths L1, L2, L3, and L4 of the first, second, third, and fourth light blocking parts 121, 122, 123, and 124 depend on the critical electric potential and reduce the electric potential difference between the first, second, third, and fourth light blocking parts 121, 122, 123, and 124 and the adjacent lines. As a result, it may be possible to prevent melting of the gate insulation layer 160 due to heat caused by the electric potential difference, as well as a short between the data line DL and the common voltage line CL.

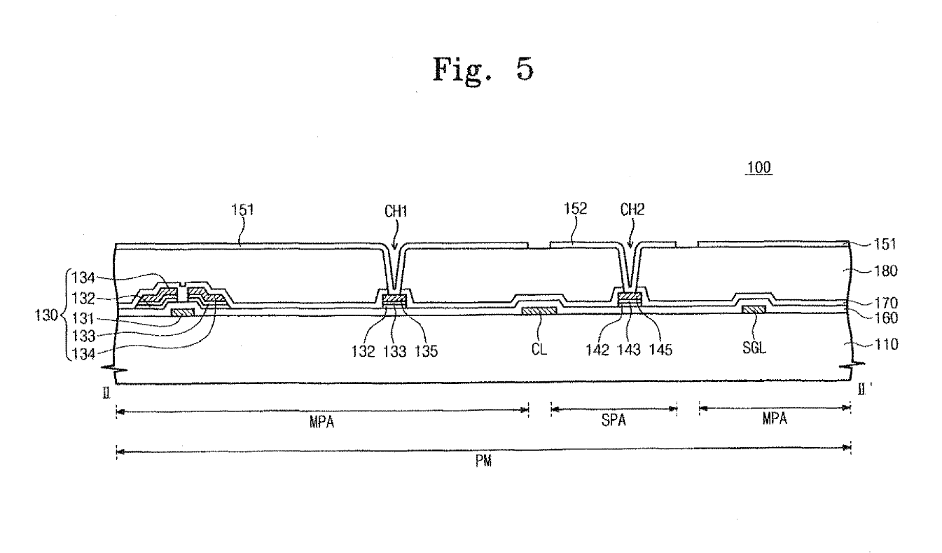

FIG. 5 is a cross-sectional view taken along line II-II′ of FIG. 1.

Referring to FIG. 1 and FIG. 5, the gate line GL1 and the data line DL are connected to the thin film transistor 130.

The thin film transistor 130 includes a gate electrode 131, an active layer 132, an ohmic contact layer 133, a source electrode 134, and a drain electrode 135.

Particularly, the gate electrode 131 is branched from the gate line GL1. The active layer 132 is branched from the active line SLa (refer to FIG. 3) and formed on the gate insulation layer 160, such that the active layer 132 may partially overlap the gate electrode 131. The ohmic contact layer 133 is formed on the active layer 132 and branched from the ohmic line SLb (refer to FIG. 3). The source electrode 134 is formed on the ohmic contact layer 133 and branched from the data line DL. The drain electrode 135 is spaced apart from the source electrode 134 and also formed on the ohmic contact layer 133. The drain electrode 135 is connected to the pixel electrode 150.

The second thin film transistor 140 is connected to the data line DL and the sub gate line SGL. The second thin film transistor 140 has the same configuration as that of the first thin film transistor 130 and therefore, detailed descriptions of the second thin film transistor 140 will be omitted.

The active layer 142 and the ohmic contact layer 143 of the second thin film transistor 140 are sequentially formed on the gate insulation layer 160, and the drain electrode 145 of the second thin film transistor 140 is connected to the pixel electrode 150.

The array substrate 100 further includes a protective layer 170 and an organic insulation layer 180. The protective layer 170 includes a silicon nitride (SiNₓ) layer or a silicon oxide (SiOₓ) layer and is formed on the first base substrate 110 on which the first and second thin film transistors 130 and 140 are formed. The organic insulation layer 180 includes an acrylic resin and is formed on the protective layer 170.

The protective layer 170 and the organic insulation layer 180 are partially removed to form a first contact hole CH1 and a second contact hole CH2. The drain electrodes 135 and 145 of the first and second thin film transistors 130 and 140 are exposed through the first and second contact holes CH1 and CH2, respectively.

The pixel electrode 150 is formed on the organic insulation layer 180. The pixel electrode 150 includes a main pixel electrode 151 and a sub pixel electrode 152. The main and sub pixel electrodes 151 and 152 include indium tin oxide (ITO) or indium zinc oxide (IZO) and are spaced apart from each other.

The main pixel electrode 151 is partially removed to form an opening. The main pixel electrode 151 includes a protrusion extending in the second direction D2 and is connected to the drain electrode 135 of the first thin film transistor 130 through the first contact hole CH1. The sub pixel electrode 152 includes a protrusion extending in the second direction D2 and is connected to the drain electrode 145 of the second thin film transistor 140.

In the present embodiment, the pixel portion PM is divided into a main pixel area MPA and a sub pixel area SPA. That is, the main and sub pixel electrodes 151 and 152 are formed in the main and sub pixel areas MPA and SPA, respectively.

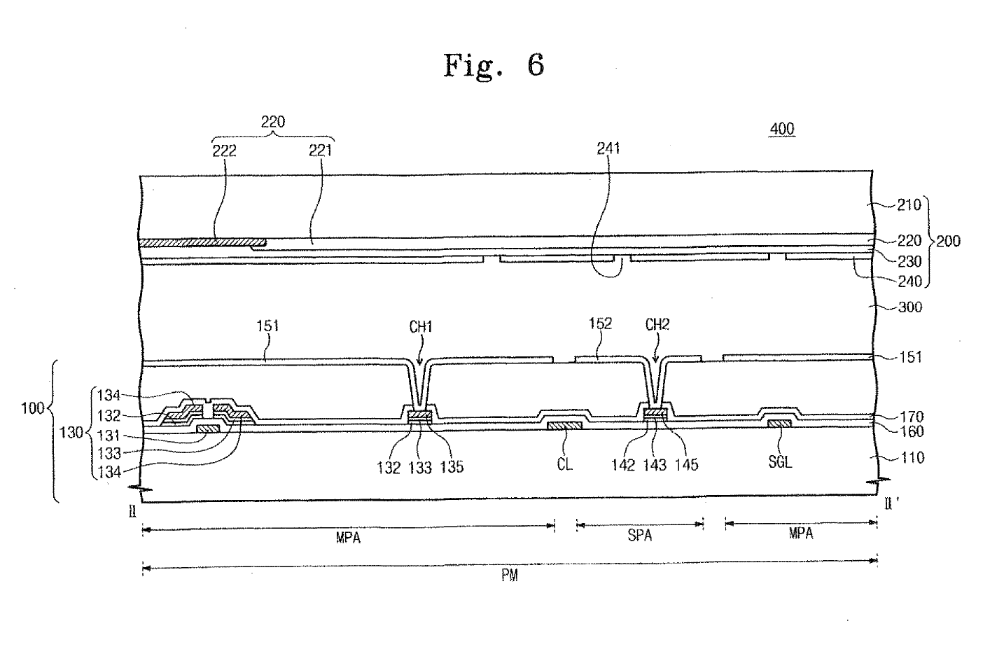

FIG. 6 is a cross-sectional view showing an exemplary embodiment of a liquid crystal display of the present invention.

Referring to FIG. 6, a liquid crystal display 400 includes the array substrate 100, an opposite substrate 200, and a liquid crystal layer 300.

The array substrate 100 includes the first base substrate 110 and the plurality of pixel portions PM. Each pixel portion PM includes a gate line GL1, a data line DL, a semiconductor line SL, a common voltage line CL, a sub gate line SGL, light blocking parts 120, first and second thin film transistors 130 and 140, and a pixel electrode 150.

The opposite substrate 200 faces the array substrate 100 and is coupled to the array substrate 100. The opposite substrate 200 includes a second base substrate 210, a color filter layer 220, an overcoating layer 230, and a common electrode 240.

The second base substrate 210 includes a transparent material through which light passes. The color filter layer 220 is formed on the second base substrate 210. The color filter layer 220 includes color pixels 221 displaying colors and a black matrix 222 blocking light that leaks from the color pixels 221. The black matrix 222 includes a metal material, such as chromium (Cr) or chromium oxide (Cr₂O₃), to surround the color pixels 221. The overcoating layer 230 is formed on the color filter layer 220 to provide a planar surface on which the common electrode 240 is disposed.

The common electrode 240 includes a transparent conductive material such as ITO, IZO, etc, and is formed on the overcoating layer 230. The common electrode 240 is partially removed from the main pixel area MPA and the sub pixel area SPA to form openings 241.

The liquid crystal layer 300 includes liquid crystal molecules and is interposed between the array substrate 100 and the opposite substrate 200. The pixel portion PM includes a plurality of domains defined by the common electrode 240, the main pixel electrode 151, and the sub pixel electrode 152, and liquid crystal molecules in each domain are aligned in different directions.

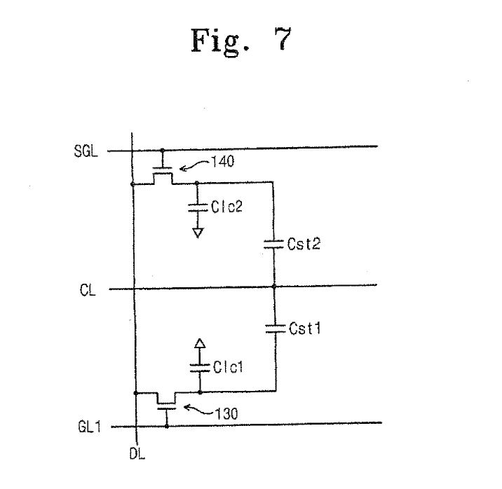

FIG. 7 is an equivalent circuit diagram of the liquid crystal display shown in FIG. 6.

Referring to FIG. 7, the liquid crystal display 400 includes a first liquid crystal capacitor Clc1 connected to the first thin film transistor 130 and a second liquid crystal capacitor Clc2 connected to the second thin film transistor 140. First and second storage capacitors Cst1 and Cst2 are connected to the common voltage line CL and to the first and second liquid crystal capacitors Clc1 and Clc2, respectively.

During a 1 H period where one pixel is driven, a first gate voltage is applied to the gate line GL1 during an H/2 period to drive the first thin film transistor 130, and a second gate voltage is applied to the sub gate line SGL during the remaining H/2 period to drive the second thin film transistor 140. When the first thin film transistor 130 is turned on in response to the first gate voltage, the first liquid crystal capacitor Clc1 is charged by a first data voltage applied to the data line DL. Then, when the second thin film transistor 140 is turned on in response to the second gate voltage, the second liquid crystal capacitor Clc2 is charged by a second data voltage, which is different from the first data voltage, that is applied to the data line DL.

According to the above, the array substrate includes light blocking parts having lower electric potential than the critical electric potential, thereby minimizing the electric potential difference between the light blocking parts and the adjacent lines when an electrostatic field is applied to the light blocking parts. Thus, it may be possible to prevent a short between the data line and the common voltage line, thereby improving the yield of the array substrate.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An array substrate, comprising:
a base substrate; and
at least one pixel part disposed on the base substrate to display an image,
the pixel part comprising:
a first signal line extending in a first direction to transmit a first signal corresponding to the image;
a second signal line extending in a second direction substantially perpendicular to the first direction to transmit a second signal corresponding to the image, the second signal line being insulated from and crossing the first signal line;
a semiconductor line disposed between the base substrate and the second signal line and disposed at a position corresponding to the second signal line; and
a plurality of light blocking parts disposed under the semiconductor line and spaced apart from each other to block light,
wherein each light blocking part has a lower electric potential than a critical electric potential that causes a short between the light blocking parts and an adjacent line to the light blocking parts.

2. The array substrate of claim 1, wherein each light blocking part comprises an area smaller than an area corresponding to the critical electric potential.

3. The array substrate of claim 1, wherein each light blocking part comprises a length shorter than a length corresponding to the critical electric potential.

4. The array substrate of claim 1, wherein the pixel part further comprises a third signal line to transmit a common voltage, the third signal line being substantially parallel to the first signal line and insulated from the second signal line while crossing the second signal line

5. The array substrate of claim 4, wherein the light blocking parts, the first signal line, and the third signal line are formed on the same layer and the light blocking parts are insulated from the first signal line and the third signal line.

6. The array substrate of claim 4, wherein each light blocking part comprises a width of about 9 micrometers to about 11 micrometers and a length of about 180 micrometers to about 190 micrometers, and the distance between each light blocking part and the adjacent line is about 10 micrometers to about 14 micrometers.

7. The array substrate of claim 6, wherein the width is about 10 micrometers, the length is less than about 185 micrometers, and the distance is about 12 micrometers.

8. The array substrate of claim 4, wherein the pixel part further comprises a fourth signal line to transmit the first signal, the fourth signal line being substantially parallel to the first signal line and formed on the same layer as the first signal line.

9. The array substrate of claim 8, wherein the third signal line is disposed between the first signal line and the fourth signal line and spaced apart from the first signal line and the fourth signal line by a first distance and a second distance, respectively, and the fourth signal line is spaced apart from an adjacent first signal line by a third distance, the third distance being smaller than the second distance.

10. The array substrate of claim 9, wherein at least two light blocking parts are disposed between the first signal line and the third signal line, one light blocking part is disposed between the third signal line and the fourth signal line, and one light blocking part is disposed between the fourth signal line and the adjacent first signal line.

11. The array substrate of claim 1, wherein the semiconductor line comprises amorphous silicon.

12. An array substrate, comprising:
a base substrate; and
at least one pixel part disposed on the base substrate to display an image,
the pixel part comprising:
a first gate line disposed on a layer and extending in a first direction to transmit a gate signal corresponding to the image;
a second gate line disposed on the layer and substantially parallel to the first gate line to transmit the gate signal;
a common voltage line disposed between the first gate line and the second gate line and substantially parallel to the first gate line and the second gate line to transmit a common voltage;
a data line extending in a second direction substantially perpendicular to the first direction to transmit a data signal corresponding to the image, the data line being insulated from and crossing the first gate line, the second gate line, and the common voltage line;
a semiconductor line disposed between the base substrate and the data line and disposed at a position corresponding to the data line; and
a plurality of light blocking parts disposed under the semiconductor line and spaced apart from each other to block light,
wherein at least two light blocking parts are disposed between the first gate line and the common voltage line, one light blocking part is disposed between the common voltage line and the second gate line, one light blocking part is disposed between the second gate line and a first gate line of an adjacent pixel part, and each light blocking part has a lower electric potential than a critical electric potential that causes a short between the light blocking parts and the first gate line, the second gate line, and the common voltage line.

13. A liquid crystal display, comprising:
an array substrate comprising a base substrate and at least one pixel part disposed on the base substrate to display an image;
an opposite substrate coupled to the array substrate; and
a liquid crystal layer interposed between the array substrate and the opposite substrate to control a light transmittance thereof,
the pixel part comprising:
a first signal line extending in a first direction to transmit a first signal corresponding to the image;
a second signal line extending in a second direction substantially perpendicular to the first direction to transmit a second signal corresponding to the image, the second signal line being insulated from and crossing the first signal line;
a semiconductor line disposed between the base substrate and the second signal line and disposed at a position corresponding to the second signal line; and
a plurality of light blocking parts disposed under the semiconductor line and spaced apart from each other to block light,
wherein each light blocking part has a lower electric potential than a critical electric potential that causes a short between the light blocking parts and a line adjacent to the light blocking parts.

14. The liquid crystal display of claim 13, wherein the array substrate further comprises a third signal line to transmit a common voltage, the third signal line being substantially parallel to the first signal line and insulated from the second signal line while crossing the second signal line.
